(19) United States
(12) Patent Application Publication
(10) Pub. No.: US 2011/0037923 A1
(43) Pub. Date: Feb. 17, 2011

(54) LIGHT CONDENSING FILM, BACKLIGHT MODULE AND LIQUID CRYSTAL DISPLAY

(75) Inventors: Fu-Ming Chuang, Hsin-Chu (TW); Han-Wen Tsai, Hsin-Chu (TW); Tzeng-Ke Shiau, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/826,714

(22) Filed: Jun. 30, 2010

(30) Foreign Application Priority Data
Aug. 14, 2009 (TW) 98127499

(51) Int. Cl. G02F 1/1335; F21V 7/04

(52) U.S. Cl. 349/62; 362/608; 362/606

(57) ABSTRACT

A light condensing film includes a reflective unit, a light-transmissive substrate, a plurality of lenses, and a plurality of refractive units. The reflective unit has a plurality of holes passing through the reflective unit, wherein the holes are distributed at the reflective unit. The light-transmissive substrate is disposed on the reflective unit. The lenses are disposed on the light-transmissive substrate. Moreover, the lenses respectively cover the holes of the reflective unit, and the light-transmissive substrate is disposed between the reflective unit and each of the lenses. The refractive units are disposed on the light-transmissive substrate and distributed among the lenses. The light-transmissive substrate is disposed between the reflective unit and each of the refractive units. Each of the refractive units has a light refraction plane surface. A backlight module and a liquid crystal display are also provided.

### CROSS-REFERENCE TO RELATED APPLICATION

This application claims the priority benefit of Taiwan application serial no. 98127499, filed on Aug. 14, 2009. The entirety of the above-mentioned patent application is hereby incorporated by reference herein and made a part of specification.

### BACKGROUND OF THE INVENTION

1. Field of the Invention

The invention is generally related to a display, a light source, and an optical device. More particularly, the invention relates to a liquid crystal display (LCD), a backlight module, and a light condensing film

2. Description of Related Art

Generally speaking, a transmissive liquid crystal display mostly operates in indoor environment. If the transmissive liquid crystal display is operated in outdoor environment, the strong outdoor light may wash out the display image. On the contrary, there is no such problem for using a reflective liquid crystal display (LCD) in outdoor environment. Since the reflective LCD requires no backlight source, the reflective LCD has relatively low power consumption.

However, even if the reflective LCD is utilized, when the strong outdoor light shines on the display surface, a part of the light is still directly reflected into the human eyes without passing through the liquid crystal. Hence, distinguishing the displayed images becomes difficult. Recent display technologies provide a half-transmissive, half-reflective LCD suitable for indoor or outdoor use. However, the issue of image washout caused by intense external light still exists due to the strong reflected light.

U.S. Pat. No. 6,933,991 provides an LCD. A refraction matching pressure sensitive adhesive (PSA) is added between layers in the LCD, Thus the reflectivity between each adjacent layers is decreased. Moreover, by using an antireflection coating (ARC) on the surface of the LCD to transmit a majority of the ambient light, the visual contrast of the LCD under strong light is enhanced. Nevertheless, the foregoing technique may not utilize the ambient light for display of the LCD.

On the other hand, U.S. Patent Publication No. 2002/0167809 provides an LCD using a shutter structure to block out the ambient light, thus the contrast for some viewing angles is improved. However, this technique also may not utilize ambient light for display of the LCD. U.S. Pat. No. 5,754,262 provides an liquid crystal panel employing a contrast enhancement assembly on the surface of the liquid crystal panel, for example a filter. While absorbing light of other colors, the filter may allow the transmission of the three RGB primary colors so as to enhance the contrast of the display. Likewise, the foregoing technique may not utilize the ambient light for display of the LCD.

Moreover, U.S. Pat. No. 6,961,108 provides an LCD including an ARC and an ambient light reflecting module, wherein the ambient light reflecting module includes a diffuser sheet and a reflective polarizer. The structure may increase the contrast of the display and utilize the ambient light for display of the LCD. However, since the reflectivity of the reflective polarizer is not high, after the effective polarized light passes through the liquid crystal module, only around 4% of the effective polarized light remains.

On the other hand, lens arrays are provided in disclosures such as U.S. Pat. Nos. 6,633,351 and 7,262,912, Taiwan Patent Publication No. 200808478, and Taiwan Patent No. M305348. U.S. Pat. No. 6,633,351 discloses an LCD. The LCD includes an optical functionality sheet. The optical functionality sheet is disposed between the backlight unit and the liquid crystal panel, and the optical functionality sheet includes a reflector, a transmissive layer, and plurality of microlens.

Moreover, Taiwan Patent Publication No. 200808478 discloses an LCD including a thin lens plate. The thin lens plate includes a substrate, a microlens array, a plurality of apertures, and a reflective material layer. The reflective material layer helps promote recirculation and recycling of light, while the apertures may allow light to pass through the thin lens plate at various angles. Taiwan Patent No. M305348 discloses an optical film. A plurality of arc units and rectangular units arranged in matrix cover the first surface of the optical film, wherein the arc units and the rectangular units may be distributed in an asymmetric manner

Furthermore, U.S. Pat. No. 7,262,912 further discloses a structure including a microlens array, a substrate, an absorbing layer, a recycling layer, a plurality of holes, and a reflective layer. The incident light may enter through the holes, get reflected by the reflective layer, and emit from the nearby holes.

### SUMMARY OF THE INVENTION

The invention provides a light condensing film capable of adjusting an exit angle of a reflected light beam and having good light condensing characteristics.

The invention provides a backlight module providing a surface light source having uniform brightness and capable of adjusting the exit angle of the reflected light beam.

The invention provides a liquid crystal display (LCD) capable of effectively using ambient light and alleviating an image washout issue of the display caused by the ambient light.

According to one embodiment of the invention, a light condensing film including a reflective unit, a light-transmissive substrate, a plurality of lenses, and a plurality of refractive units is provided. The reflective unit has a plurality of holes passing through the reflective unit, and the holes are distributed at the reflective unit. The light-transmissive substrate is disposed on the reflective unit. The lenses are disposed on the light-transmissive substrate and respectively cover the holes of the reflective unit. The light-transmissive substrate is disposed between the reflective unit and each of the lenses. The refractive units are disposed on the light-transmissive substrate and distributed among the lenses, and the light-transmissive substrate is disposed between the reflective unit and each of the refractive units. Each of the refractive units has a light refraction plane surface.

Another embodiment of the invention provides a backlight module including a backlight unit and the aforementioned light condensing film. The backlight unit is capable of providing an illumination beam. The light condensing film is disposed on the backlight unit and located in a transmission path of the illumination beam.

Another embodiment of the invention provides an LCD including the aforementioned backlight unit, the aforementioned light condensing film, and a liquid crystal panel. The liquid crystal panel is disposed on the light condensing film. Each of the refractive units is disposed between the liquid crystal panel and the light-transmissive substrate.

In summary, the light condensing film according to the embodiments of the invention has refractive units to improve the exit angle of the reflected light beam. Therefore, in the backlight module and the LCD according to the embodiments of the invention, the angle of the reflected light beam for the liquid crystal panel may be different from the reflected angle of the light beam passing through the light condensing film. Consequently, the image washout issue of the display caused by the ambient light is alleviated. Since the light condensing film according to the embodiments of the invention has mutually corresponding holes and lenses, the light condensing film may provide a good light condensing effect. The light condensing film may not only direct illumination beams of the light emitting devices into the liquid crystal panel, thereby allowing a large portion of the illumination beams to pass through the liquid crystal panel, but also reflect external ambient light passing through the liquid crystal panel back to outside through the liquid crystal panel. Therefore, the external ambient light is used as the backlight to enhance the brightness and the contrast of the LCD. Consequently, whether there is external ambient light or not, the backlight module and the LCD according to the embodiments of the invention may be used, and the displayed images are easy to distinguish.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a liquid crystal display (LCD) in accordance with a first embodiment of the invention.

FIG. 2 is a partially magnified view illustrating a region A of the LCD 100 depicted FIG. 1.

FIG. 3 is a partially magnified view illustrating a region B of the LCD depicted in FIG. 1.

FIG. 4 is a perspective schematic view illustrating an LCD in accordance with a second embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### FIRST EMBODIMENT

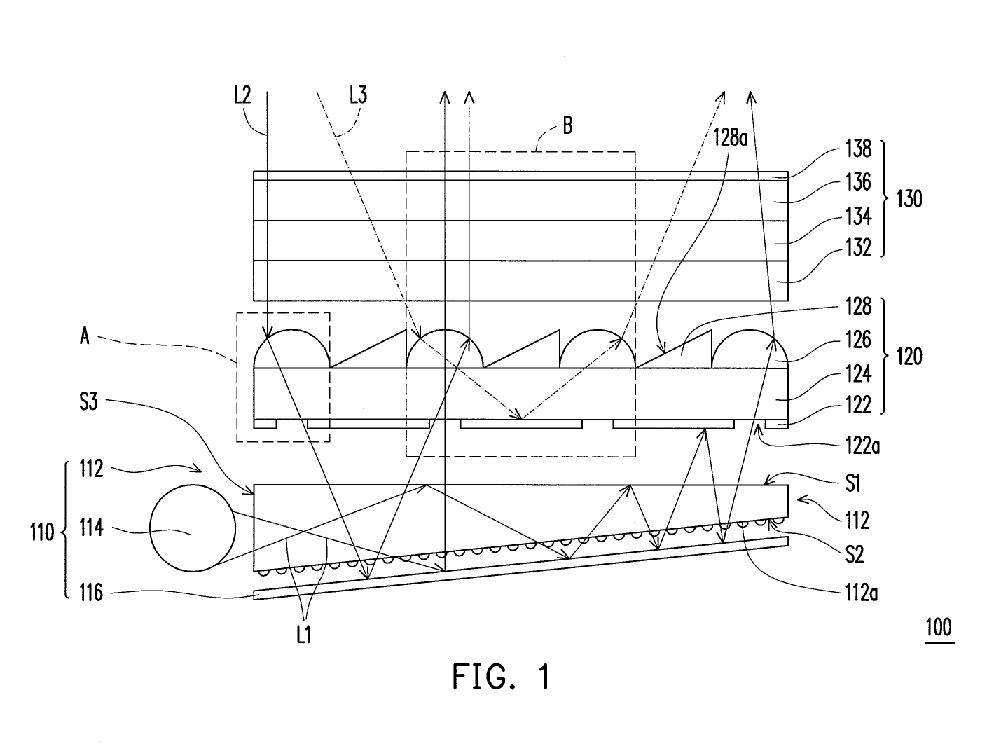

Referring to FIG. 1, the LCD 100 according to the embodiment of the invention includes a backlight unit 110, a light condensing film 120, and a liquid crystal panel 130. The backlight unit 110 is capable of providing an illumination beam L1. The light condensing film 120 is disposed on the backlight unit 110 and located in a transmission path of the illumination beam L1. In addition, the liquid crystal panel 130 is disposed on the light condensing film 120.

As shown in FIG. 1, the light condensing film 120 according to the embodiment includes a reflective unit 122, a light-transmissive substrate 124, a plurality of lenses 126, and a plurality of refractive units 128. The reflective unit 122 has a plurality of holes 122a passing through the reflective unit 122, and the holes 122a are distributed at the reflective unit 122. Each of the holes 122a is disposed around a focus of a corresponding one of the lenses 126, and the optical axis of the lenses 126 passes through the corresponding one of the holes 122a. On the other hand, the light-transmissive substrate 124 is disposed on the reflective unit 122 and capable of allowing passage of the light beam. Additionally, the lenses 126 are disposed on the light-transmissive substrate 124, and the lenses 126 respectively cover the holes 122a of the reflective unit 122. Moreover, the light-transmissive substrate 124 is disposed between the reflective unit 122 and each of the lenses 126.

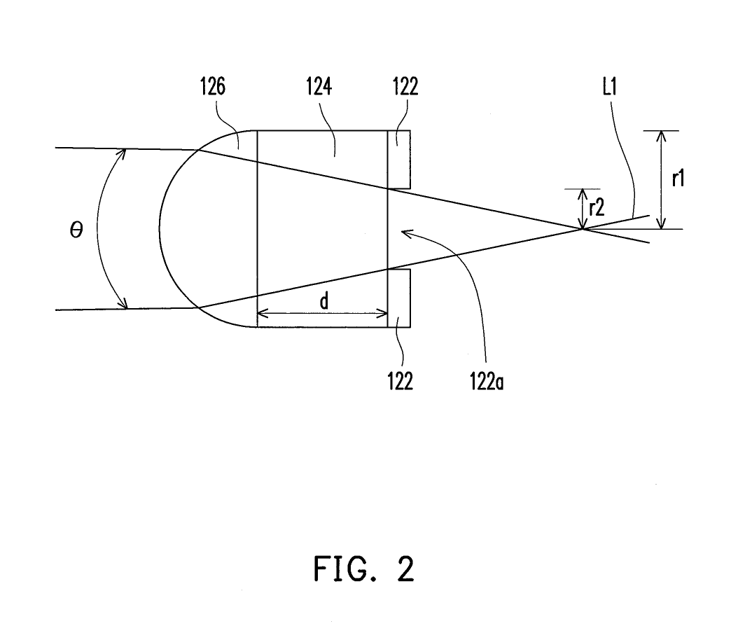

Referring to FIG. 2, FIG. 2 depicts a combination of the lenses 126, the light-transmissive substrate 124, and the reflective unit 122, wherein θ is a viewing angle of a transmissive beam (e.g., the illumination beam L1), d is a thickness of the light-transmissive substrate 124, and r1 and r2 are respectively the outer radius r1 of the lenses 126 and the inner radius r2 of the holes 122a. The viewing angle θ changes according to the thickness d and a ratio of the inner radius r2 to the outer radius r1.

More specifically, when the thickness d of the light-transmissive substrate 124 becomes thinner, the viewing angle θ of the transmissive beam (e.g., the illumination beam L1) becomes larger. When the thickness d of the light-transmissive substrate 124 becomes thicker, the viewing angle θ of the transmissive beam becomes smaller. On the other hand, as the ratio of the inner radius r2 to the outer radius r1 becomes larger (e.g. the inner radius r2 of the holes 122a is increasing), the viewing angle θ of the transmissive beam becomes larger. As the ratio of the inner radius r2 to the outer radius r1 becomes smaller (e.g. the inner radius r2 of the holes 122a is decreasing), the viewing angle θ of the transmissive beam becomes smaller. Therefore, a designer may adjust the viewing angle θ of the transmissive beam according to needs. In the embodiment of the invention, a range of the viewing angle θ of the transmissive beam is approximately ±10 degrees to ±30 degrees. An LCD having a small range of viewing angle θ may provide an anti-spying capability. In the embodiment, the ratio of the inner radius r2 of the holes 122a to the outer radius r1 of the corresponding lenses 126 is less than 0.5. Consequently, the reflective unit 122 may reflect a large portion of an ambient light from outside.

Continuing reference to FIG. 1, the refractive unit 128 is disposed on the light-transmissive substrate 124 and distributed among the lenses 126. In the embodiment of the invention, a ratio of a total projection area of the refractive units 128 on the light-transmissive substrate 124 to a total projection area of the lenses 126 on the light-transmissive substrate 124 is in a range from 0.5 to 1 (FIG. 1 uses 0.5 for the ratio of the total area as an example). Moreover, the light-transmissive substrate 124 is disposed between the reflective unit 122 and each of the refractive units 128. Each of the refractive units 128 has a light refraction plane surface 128a, wherein each of the light refractive plane surface 128a is parallel or tilted with respect to the light-transmissive substrate 124 (FIG. 1 depicts the light refractive plane surface 128a tilted with respect to the light-transmissive substrate 124 as an example).

In another embodiment of the invention, a ratio of the total projection area of the refractive units 128 on the light-transmissive substrate 124 to the total projection area of the lenses 126 on the light-transmissive substrate 124 is in a range from 0.2 to 1.

Moreover, the liquid crystal panel 130 is disposed on the light condensing film 120, and each of the refractive units 128 is disposed between the liquid crystal panel 130 and the light-transmissive substrate 124. In addition, the liquid crystal panel 130 according to the embodiment of the invention includes a first substrate 132, a liquid crystal layer 134, a second substrate 136, and an antireflection coating (ARC) 138. For example, the first substrate 132 is a color filter substrate, and the second substrate 136 is a pixel array substrate. Moreover, the liquid crystal layer 134 is disposed between the first substrate 132 and the second substrate 136, and the ARC 138 is disposed on the second substrate 136 and located on a side of the liquid crystal panel 130 opposite to the light condensing film 120. The ARC 138 may increase the transmittance of the ambient light (e.g., for ambient light beams L2 and L3). Therefore, the external ambient light may be effectively utilized by the LCD 100, and further the contrast and the viewability of the display are enhanced.

In addition, the LCD 100 according to the embodiment is a side-incident type LCD. As shown in FIG. 1, the backlight unit 110 includes a light guide plate 112, at least a light emitting device 114, and a reflector 116. The light guide plate 112 has a first surface S1, a second surface S2 opposite to the first surface S1, and an incident surface S3 connected to the first surface S1 and the second surface S2. The first surface S1 faces the light condensing film 120, and the light emitting device 114 is disposed beside the incident surface S3, wherein the light guide plate 112 is capable of guiding the illumination beam L1. In the embodiment of the invention, the illumination beam L1 enters the light guide plate 112 through the incident surface S3, and the illumination beam L1 is transmitted to the light condensing film 120 through the first surface S1.

Specifically, after experiencing the effects from a plurality of optical microstructures 112a on the light guide plate 112, the illumination beam L1 is transmitted towards the reflector 116, and the reflector reflects the illumination beam L1 towards the first surface S1, and afterwards the illumination beam L1 is transmitted to the light condensing film 120 through the first surface S1. In other embodiments of the invention, the LCD 100 may include two light emitting devices 114, wherein the other light emitting device 114 (not drawn) may be disposed on a side of the light guide plate 112 opposite to the incident surface S3. Moreover, the light emitting device 114 is a light emitting diode (LED) or a cold cathode fluorescent lamp (CCFL), for example.

Again referring to FIG. 1, FIG. 1 depicts three beams L1-L3, wherein the illumination beam L1 is an illumination beam provided by the light emitting device 114, and the beams L2 and L3 are external ambient light beams (e.g., ambient light from a fluorescent lamp or sunlight). In the embodiment of the invention, each of the holes 122a of the LCD 100 is disposed around the focus of the corresponding one of the lenses 126, and the optical axis of each of the lenses 126 passes through the corresponding one of the holes 122a. As shown in FIG. 1, when the illumination beam L1 is repeatedly reflected in the light guide plate 112 until the illumination beam L1 is transmitted to the reflective unit 122 from the first surface S1 of the light guide plate 112, the reflective unit 122 reflects the illumination beam L1 back towards the light guide plate 112 until the illumination beam L1 is transmitted towards the lenses 126 through the holes 122a. In addition, the illumination beam L1 may be directly reflected by the reflector 116 and transmitted in a direction towards the holes 122a. According to the embodiment of the invention, the lenses 126 are convex lenses capable of providing substantially good light condensing characteristics. Therefore, by being passed through the holes 122a and being refracted by the lenses 126, the illumination beam L1 is converged so as to have a smaller light exiting angle. Thereby, a large portion of the illumination beam L1 may be transmitted to the liquid crystal panel 130 to use as a backlight source of the LCD 100, thus increasing the brightness of the display.

Moreover, when the ambient beam L2 is perpendicularly transmitted towards the liquid crystal panel 130, the ARC 138 allows a large portion of the ambient beam L2 to transmit towards the lenses 126. Next, the ambient beam L2 parallel to the optical axis of the lenses 126 is refracted by the lenses 126, and after being refracted, the ambient beam L2 passes through the focus of the lenses 126. Since the holes 122a according to the embodiment are disposed around the focus of the lenses 126, and the optical axis of each of the lenses 126 passes through the corresponding one of the holes 122a, the ambient beam L2 passing through the focus of the lenses 126 may pass through the holes 122a. Consequently, the ambient beam L2 is transmitted towards the backlight unit 110. Thereafter, the reflector 116 of the backlight unit 110 reflects the ambient beam L2 through the holes 122a nearby, the ambient beam L2 is transmitted back through the focus of the lenses 126, and afterwards the ambient beam L2 is again refracted by the lenses 126. Therefore, the ambient beam L2 is transmitted towards the liquid crystal panel 130 in a perpendicular direction with respect to the liquid crystal panel 130.

Moreover, when the external ambient beam L3 is tramsmitted towards the liquid crystal 130 at a tilt, and the ambient beam L3 is refracted by the lenses 126 to transmit towards the reflective unit 122, the reflective unit 122 reflects the ambient beam L3. Thereafter, as shown in FIG. 1, the lenses 126 transmits the ambient beam L3 from the liquid crystal panel 130 back towards the outside. Accordingly, whether the ambient beam L2 perpendicularly transmitted towards the liquid crystal panel 130 or the ambient beam L3 transmitted towards the liquid crystal panel 130 at a tilt, the ambient beams L2 and L3 may all be reflected by the light condensing film 120 back towards the liquid crystal panel 130. The ambient beams L2 and L3 transmitted towards the outside from the liquid crystal panel 130 may be utilized as a backlight of the LCD 100, thus enhancing the brightness and contrast of the display. Furthermore, since the ratio of the inner radius r2 of the holes 122a to the outer radius r1 of the corresponding lenses 126 is less than 0.5, the reflective unit 122 may reflect a large portion of the ambient light (e.g., the ambient beams L2 and L3).

In addition, when there are no external ambient light, the illumination beam L1 from the backlight unit 114 is also transmitted towards the liquid crystal panel 130 through the holes 122a, to provide the backlight of the display. Therefore, the LCD 100 according to the embodiment of the invention may be used whether there is ambient light or not. More specifically, if there is no ambient light around, the illumination beam L1 may be used as the main backlight source of the LCD 100. On the other hand, if there is ambient light around, the external ambient beams L2 and L3 may be used in conjunction with the illumination beam L1 as the backlight source of the LCD 100, thereby enhancing the brightness of the display. Moreover, the LCD 100 according to the embodiment uses a plurality of lenses 126 to produce the light condensing effect, wherein the spacing of each of the lenses 126 may be randomly adjusted, and the lenses 126 may be arranged regularly or irregularly in a matrix. In contrast to conventional techniques, since the embodiment of the invention does not use two prism sheets arranged mutually perpendicularly for light condensing, the moiré effect caused between two prism sheets or between one prism sheet and the pixels may be prevented.

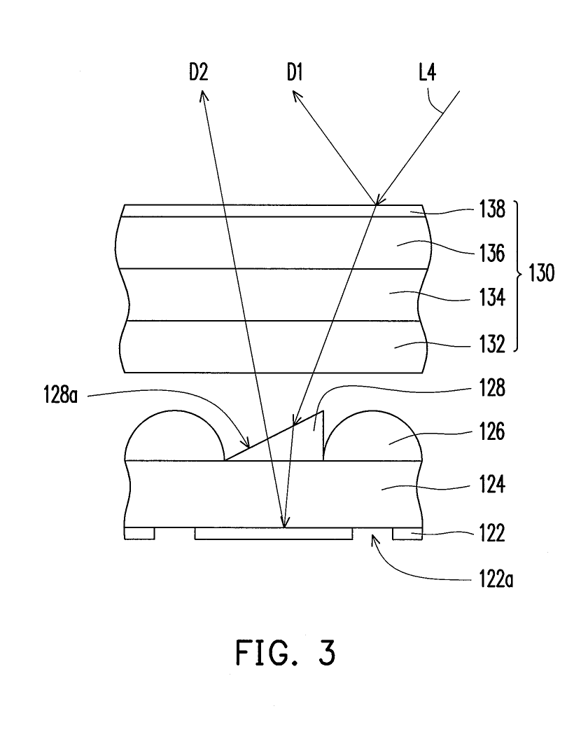

FIG. 3 is another schematic view illustrating an external ambient beam L4 transmitting towards the liquid crystal 130. As shown in FIG. 3, when the ambient beam L4 is tramsmitted towards the liquid crystal panel 130 from the outside, a small portion of the ambient beam L4 is reflected towards a direction D1, for example, and a large portion of the ambient beam L4 transmits through the ARC 138 and transmits toward the liquid crystal panel 130. When the transmitted ambient beam L4 is tramsmitted toward the light refraction plane surface 128a of the refractive units 128, the ambient beam L4 is refracted by the refractive units 128, and the ambient beam L4 is transmitted towards the reflective unit 122 at a refractive angle smaller than the incident angle. Thereafter, the reflective unit 122 reflects the ambient beam L4 towards the refractive units 128, and the refractive units 128 refracts the ambient beam L4 towards a direction D2 different from the direction D1. In the embodiment of the invention, the angle difference between the directions D1 and D2 is approximately 10 degrees.

The ambient beam L4 oriented at the direction D1 is a beam directly reflected back towards the outside without passing through the liquid crystal panel 130. The ambient beam L4 refracted towards the direction D2 is a beam having pixel information, reflected by the reflective unit 122, and thereafter passing through the liquid crystal panel 130. Since a beam having pixel information and a beam not having pixel information are respectively refracted towards different directions, the beam oriented at the direction D1 is prevented from affecting the beam oriented at the direction D2. Consequently, the viewability of the display is enhanced. Moreover, the refractive units 128 according to the embodiment of the invention is a prism, and the light refraction plane surfaces 128a of the refractive units 128 may be substantially parallel to each other. Therefore, the beams having pixel information may be refracted by the refractive units 128 to approximately the same direction, thereby allowing the user of the display to observe images with uniform brightness at the direction.

### SECOND EMBODIMENT

The LCD 200 is similar to the LCD 100, and a difference between the LCD 100 and the LCD 200 lies in that the LCD 200 is a direct-type LCD.

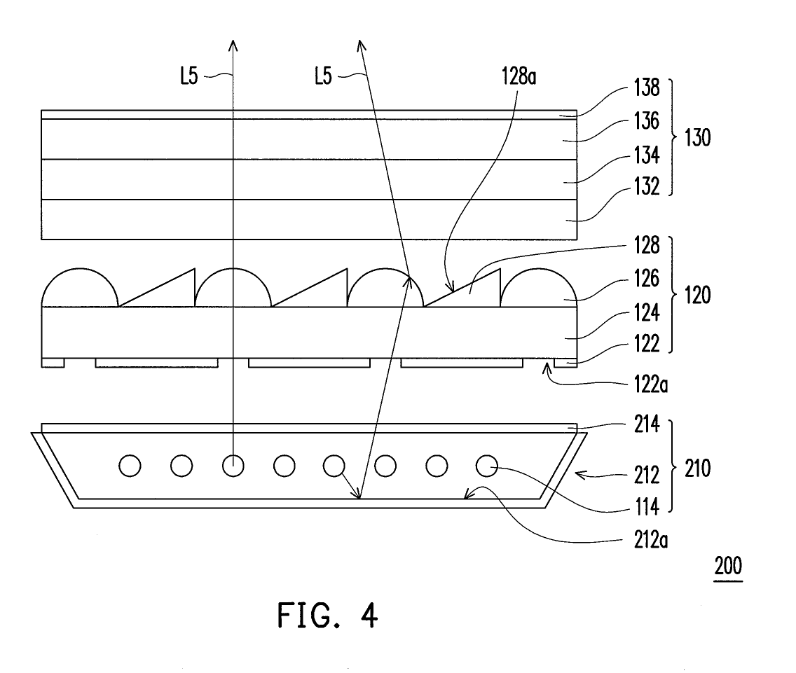

Referring to FIG. 4, the LCD 200 according to the embodiment of the invention includes a backlight unit 210, a light condensing film 120, and a liquid crystal panel 130. The backlight unit 210 includes a light box 212, a plurality of light emitting devices 114, and a diffusion plate 214. As shown in FIG. 4, the light emitting devices 114 are disposed in the light container 212 and located between the diffusion plate 214 and an internal reflective surface 212a. Moreover, the diffusion plate 214 is disposed between each of the light emitting devices 114 and the light condensing film 120. The internal reflective surface 212a of the light box 212 may reflect the light emitted by the light emitting devices 114 towards the diffusion plate 214. In addition, the diffusion plate 214 is disposed on the light box 212 and located above the light emitting devices 114, so as to uniformly diffuse a beam to present a surface light source. Consequently, after an illumination beam L5 emitted by the light emitting devices 114 passes through the holes 122a, the illumination beam L5 is refracted by the lenses 126 towards the liquid crystal panel 130, to serve as a backlight of the LCD 200. On the other hand, an external ambient beam may also be reflected by the light condensing film 120 back to the liquid crystal panel 130 to serve as the backlight of the LCD 200. For a detailed description of this section, reference may be found in the first embodiment of the invention, therefore no further description is contained herein.

In light of the foregoing description, the light condensing film according to embodiments of the invention has mutually corresponding holes and lenses, and consequently the light condensing film is capable of providing a good light condensing effect. The light condensing film is not only capable of directing illumination beams of the light emitting devices towards the liquid crystal panel, thereby allowing a large portion of the illumination beams to pass through the liquid crystal panel, the light condensing film may also reflect external ambient light passing through the liquid crystal panel back towards the outside through the liquid crystal panel. Hence, the external ambient light is used as the backlight. Consequently, whether there is an outside ambient light or not, the backlight module and the LCD according to embodiments of the invention may be used, and the displayed images are easily distinguishable.

Moreover, since the refractive units of the light condensing film according to embodiments of the invention may improve the exit angle of the reflected beam, the illumination beam having pixel information is reflected at a different direction compared to the illumination beam not having pixel information. Therefore, the image washout issue caused by the ambient light is alleviated. Consequently, the LCD according to the embodiments of the invention may provide a display having high brightness and high viewability. In addition, by using the light condensing film to produce the light condensing effect, the moiré effect occurring in conventional techniques may be avoided. The exit angle of the illumination beams from the light condensing film allows the designer to design the exit angle according to different needs.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light condensing film, comprising:
a reflective unit having a plurality of holes passing through the reflective unit, wherein the holes are distributed at the reflective unit;
a light-transmissive substrate disposed on the reflective unit;
a plurality of lenses disposed on the light-transmissive substrate and respectively covering the holes of the reflective unit, wherein the light-transmissive substrate is disposed between the reflective unit and each of the lenses; and
a plurality of refractive units disposed on the light-transmissive substrate and distributed among the lenses, wherein the light-transmissive substrate is disposed between the reflective unit and each of the refractive units, and each of the refractive units has a light refraction plane surface.

2. The light condensing film as claimed in claim 1, wherein each of the holes is disposed around a focus of a corresponding one of the lenses.

3. The light condensing film as claimed in claim 1, wherein an optical axis of each of the lenses passes through a corresponding one of the holes.

4. The light condensing film as claimed in claim 1, wherein each of the refractive units comprises a prism.

5. The light condensing film as claimed in claim 1, wherein a ratio of a total projection area of the refractive units on the light-transmissive substrate to a total projection area of the lenses on the light-transmissive substrate is in a range from 0.2 to 1.

6. The light condensing film as claimed in claim 1, wherein a ratio of an inner radius of each of the holes to an outer radius of a corresponding one of the lenses is less than 0.5.

7. A backlight module, comprising:
a backlight unit capable of providing an illumination beam; and
a light condensing film disposed on the backlight unit and located in a transmission path of the illumination beam, the light condensing film comprising:
a reflective unit having a plurality of holes passing through the reflective unit, wherein the holes are distributed at the reflective unit;
a light-transmissive substrate disposed on the reflective unit;
a plurality of lenses disposed on the light-transmissive substrate and respectively covering the holes of the reflective unit, wherein the light-transmissive substrate is disposed between the reflective unit and each of the lenses; and
a plurality of refractive units disposed on the light-transmissive substrate and distributed among the lenses, wherein the light-transmissive substrate is disposed between the reflective unit and each of the refractive units, and each of the refractive units has a light refraction plane surface.

8. The backlight module as claimed in claim 7, wherein each of the holes is disposed around a focus of a corresponding one of the lenses.

9. The backlight module as claimed in claim 7, wherein an optical axis of each of the lenses passes through a corresponding one of the holes.

10. The backlight module as claimed in claim 7, wherein each of the refractive units comprises a prism.

11. The backlight module as claimed in claim 7, wherein a ratio of a total projection area of the refractive units on the light-transmissive substrate to a total projection area of the lenses on the light-transmissive substrate is in a range from 0.2 to 1.

12. The backlight module as claimed in claim 7, wherein a ratio of an inner radius of each of the holes to an outer radius of a corresponding one of the lenses is less than 0.5.

13. The backlight module as claimed in claim 7, wherein the backlight unit comprises:
a light box having an internal reflective surface;
a plurality of light emitting devices disposed in the light box; and
a diffusion plate disposed between each of the light emitting devices and the light condensing film, wherein the light emitting devices are disposed between the diffusion plate and the internal reflective surface.

14. The backlight module as claimed in claim 7, wherein the backlight unit comprises:
a light guide plate having a first surface, a second surface opposite to the first surface, and an incident surface connected to the first surface and the second surface, wherein the first surface faces the light condensing film;
at least a light emitting device disposed beside the incident surface; and
a reflector disposed beside the second surface, wherein the light guide plate is disposed between the light condensing film and the reflector.

15. A liquid crystal display, comprising:
a backlight unit capable of providing an illumination beam;
a light condensing film disposed on the backlight unit and located in a transmission path of the illumination beam, the light condensing film comprising:
a reflective unit having a plurality of holes passing through the reflective unit, wherein the holes are distributed at the reflective unit;
a light-transmissive substrate disposed on the reflective unit;
a plurality of lenses disposed on the light-transmissive substrate and respectively covering the holes of the reflective unit, wherein the light-transmissive substrate is disposed between the reflective unit and each of the lenses; and
a plurality of refractive units disposed on the light-transmissive substrate and distributed among the lenses, wherein the light-transmissive substrate is disposed between the reflective unit and each of the refractive units, and each of the refractive units has a light refractive plane surface; and
a liquid crystal panel disposed on the light condensing film, wherein each of the refractive units is disposed between the liquid crystal panel and the light-transmissive substrate.

16. The liquid crystal display as claimed in claim 15, wherein each of the holes is disposed around a focus of a corresponding one of the lenses.

17. The liquid crystal display as claimed in claim 15, wherein each of the refractive units comprises a prism.

18. The liquid crystal display as claimed in claim 15, wherein a ratio of a total projection area of the refractive units in the light-transmissive substrate to a total projection area of the lenses on the light-transmissive substrate is in a range from 0.2 to 1.

19. The liquid crystal display as claimed in claim 15, wherein a ratio of an inner radius of each of the holes to an outer radius of a corresponding one of the lenses is less than 0.5.

20. The liquid crystal display as claimed in claim 15, further comprising an antireflection coating disposed on a side of the liquid crystal panel opposite to the light condensing film.
